(19) United States
(12) Patent Application Publication
(10) Pub. No.: US 2023/0108224 A1
(43) Pub. Date: Apr. 6, 2023

(54) IRON-BASED SOFT MAGNETIC POWDER FOR DUST CORES, DUST CORE, AND METHODS OF PRODUCING SAME

(71) Applicant: JFE STEEL CORPORATION, Chiyoda-ku, Tokyo (JP)

(72) Inventors: Takuya TAKASHITA, Chiyoda-ku, Tokyo (JP); Takechika NAKAMURA, Chiyoda-ku, Tokyo (JP)

(73) Assignee: JFE STEEL CORPORATION, Chiyoda-ku, Tokyo (JP)

(21) Appl. No.: 17/907,272

(22) PCT Filed: Dec. 18, 2020
(86) PCT No.: PCT/JP2020/047540

§ 371 Date: Sep. 26, 2022

(30) Foreign Application Priority Data
Apr. 2, 2020 (JP) 2020-066992

(51) Int. Cl. H01F 1/26; B22F 1/102; B22F 1/16; C22C 33/02; H01F 27/255; H01F 41/02

(52) U.S. Cl. CPC H01F 1/26; B22F 1/102; B22F 1/16; C22C 33/02; H01F 27/255; H01F 41/0246; C22C 2202/02; B22F 2999/00

(57) ABSTRACT

Provided is an iron-based soft magnetic powder for dust cores that enables production of a dust core having high density and low iron loss. An iron-based soft magnetic powder for dust cores comprises: an iron-based soft magnetic powder; a condensed aluminum phosphate layer on particle surfaces of the iron-based soft magnetic powder; and a silicone resin layer on a surface of the condensed aluminum phosphate layer, wherein the condensed aluminum phosphate layer is a continuous coating, and a total mass of the condensed aluminum phosphate layer and the silicone resin layer is 0.60 mass % or less with respect to 100 mass % of a total mass of the iron-based soft magnetic powder, the condensed aluminum phosphate layer, and the silicone resin layer.

### TECHNICAL FIELD

The present disclosure relates to an iron-based soft magnetic powder for dust cores, a dust core, and methods of producing the same.

### BACKGROUND

Magnetic cores used in motors, transformers, and the like are required to have high magnetic flux density and low iron loss. Conventionally, electrical steel sheets have been stacked in magnetic cores for motors, yet in recent years, dust cores have attracted attention.

The most notable characteristic of a dust core is that a 3D magnetic circuit can be formed. In the case of using electrical steel sheets as material, electrical steel sheets are stacked to form a magnetic core, and accordingly the degree of freedom for the shape is limited. A dust core, on the other hand, is formed by pressing soft magnetic particles each having an insulating coating. Since the shape of the dust core can be changed by changing the die, a greater degree of freedom for the shape than with electrical steel sheets can be obtained.

Press forming is also a shorter process than stacking electrical steel sheets and is less expensive. Combined with the low cost of the base powder, dust cores achieve excellent cost performance.

Moreover, in the case of using electrical steel sheets as material, since the steel sheets whose surfaces are insulated are stacked, not only the magnetic properties of the steel sheets in the direction parallel to the steel sheet surface and the direction perpendicular to the surface differ, but also the magnetic properties of the steel sheets in the direction perpendicular to the surface are poor. By contrast, in a dust core, each particle is coated with an insulating coating, yielding uniform magnetic properties in every direction. Dust cores are therefore advantageous in formation of 3D magnetic circuits.

Thus, dust cores enable designing of 3D magnetic circuits, and have excellent cost performance. In view of this, to achieve size reduction of motors, reduction of use of rare earth elements, cost reduction, and the like demanded in recent years, research and development of motors with 3D magnetic circuits using dust cores have flourished.

In size reduction of motors, the importance of iron loss reduction at medium to high frequencies (800 Hz to 3 kHz) increases due to an increase in rotational speed associated with size reduction. Dust cores, however, have higher iron loss and lower magnetic flux density than electrical steel sheets, and therefore have hardly been put to practical use thus far.

To put a dust core to practical use, it is important to maintain the insulation between particles not only in the green compact stage but also when performing stress relief annealing on the green compact at high temperature (for example, 600° C.) in order to reduce the iron loss of the dust core at medium to high frequencies. It is also important to improve the magnetic flux density. To do so, the density of the dust core needs to be increased.

Regarding soft magnetic powders for dust cores, for example, JP 2012-84803 A (PTL 1), JP 4044591 B1 (PTL 2), and WO 2012/124032 A1 (PTL 3) each propose an iron-based soft magnetic powder for dust cores having silicone resin on a phosphoric acid-based chemical conversion layer.

JP 2014-236118 A (PTL 4) proposes a soft magnetic powder mixed with a condensed phosphoric acid metal salt of a predetermined amount and coated with the condensed phosphoric acid metal salt. JP 2015-230930 A (PTL 5) proposes a soft magnetic powder mixed with a condensed phosphoric acid metal compound of a predetermined amount and further mixed with an insulating fine powder and coated with a coating containing the condensed phosphoric acid metal compound.

JP 2019-151909 A (PTL 6) proposes a soft magnetic material comprising a Fe—Si alloy powder and an insulating coating covering the particle surfaces of the Fe—Si alloy powder, wherein the insulating coating has a silicone oligomer layer and a silicone resin layer.

### CITATION LIST

### Patent Literature

PTL 1: JP 2012-84803 A

PTL 2: JP 4044591 B1

PTL 3: WO 2012/124032 A1

PTL 4: JP 2014-236118 A

PTL 5: JP 2015-230930 A

PTL 6: JP 2019-151909 A

### SUMMARY

### Technical Problem

In PTL 1 to PTL 3, when forming a phosphoric acid-based chemical conversion layer on an iron powder, an orthophosphoric acid dilute aqueous solution is used. An iron powder has a greater specific surface area than bulk material, and oxidizes easily when exposed to moisture such as an aqueous solution. The oxidation of the iron powder causes an increase in hysteresis loss in the dust core formed from the powder, and leads to insufficient iron loss reduction. PTL 4 points out the possibility that, in the case where an orthophosphoric acid dilute aqueous solution is used, the iron-based soft magnetic powder for dust cores becomes hygroscopic due to free orthophosphoric acid. This problem of free orthophosphoric acid is unavoidable even when a solution of an organic solvent of orthophosphoric acid is used. Moreover, the use of an organic solvent is expensive, and has problems such as ignition. Thus, safety measures are required and a dedicated production line is needed, which is burdensome.

In PTL 4 and PTL 5, a soft magnetic powder mixed with a powder of a condensed phosphoric acid metal salt or a condensed phosphoric acid compound needs to be further mixed with a large amount of binding resin in order to ensure formability in dust core production. The amount of the binding resin is as high as 2.0 mass % in the examples of these documents. This makes it difficult to increase the densities of dust cores.

PTL 6 is focused on the extremely limited need of decreasing the magnetic permeability of dust cores. For this aim, a Fe—Si alloy powder needs to be coated with a large amount of a specific insulating coating. With such a powder, it is difficult to increase the densities of dust cores.

It could therefore be helpful to provide an iron-based soft magnetic powder for dust cores that enables production of a dust core having high density and low iron loss.

### Solution to Problem

Upon careful examination, we discovered the following: By causing condensed aluminum phosphate, which has high adhesiveness to iron-based soft magnetic powders, to adhere to particle surfaces of an iron-based soft magnetic powder as a continuous coating and further causing silicone resin with high heat resistance to be held by this continuous coating, the combination of the properties of the condensed aluminum phosphate layer and the properties of the silicone resin layer makes it possible to achieve favorable insulation even by a small amount, so that a dust core having high density and low iron loss can be produced.

We thus provide:

[1] An iron-based soft magnetic powder for dust cores, comprising: an iron-based soft magnetic powder; a condensed aluminum phosphate layer on particle surfaces of the iron-based soft magnetic powder; and a silicone resin layer on a surface of the condensed aluminum phosphate layer, wherein the condensed aluminum phosphate layer is a continuous coating, and a total mass of the condensed aluminum phosphate layer and the silicone resin layer is 0.60 mass % or less with respect to 100 mass % of a total mass of the iron-based soft magnetic powder, the condensed aluminum phosphate layer, and the silicone resin layer.

[2] The iron-based soft magnetic powder for dust cores according to [1], wherein the total mass of the condensed aluminum phosphate layer and the silicone resin layer is 0.10 mass % or more and 0.60 mass % or less with respect to 100 mass % of the total mass of the iron-based soft magnetic powder, the condensed aluminum phosphate layer, and the silicone resin layer.

[3] The iron-based soft magnetic powder for dust cores according to [1] or [2], wherein a mass ratio of the condensed aluminum phosphate layer to the total mass of the condensed aluminum phosphate layer and the silicone resin layer is 0.2 to 0.9. [4] A dust core obtainable by pressing and heat treating the iron-based soft magnetic powder for dust cores according to any one of [1] to [3].

[5] A method of producing an iron-based soft magnetic powder for dust cores that includes: an iron-based soft magnetic powder; a condensed aluminum phosphate layer on particle surfaces of the iron-based soft magnetic powder; and a silicone resin layer on a surface of the condensed aluminum phosphate layer, the method comprising heating and mixing the iron-based soft magnetic powder and a condensed aluminum phosphate powder to obtain the iron-based soft magnetic powder having the condensed aluminum phosphate layer on the particle surfaces thereof, and thereafter adhering a silicone resin to the surface of the condensed aluminum phosphate layer to form the silicone resin layer, wherein a total mass of the condensed aluminum phosphate powder and the silicone resin is 0.60 mass % or less with respect to 100 mass % of a total mass of the iron-based soft magnetic powder, the condensed aluminum phosphate powder, and the silicone resin.

[6] The method of producing an iron-based soft magnetic powder for dust cores according to [5], wherein a maximum arrival temperature in the heating and mixing is 100° C. or more and 200° C. or less.

[7] The method of producing an iron-based soft magnetic powder for dust cores according to [5] or [6], wherein a solution obtained by dissolving the silicone resin in an organic solvent and the iron-based soft magnetic powder having the condensed aluminum phosphate layer are kneaded and thereafter dried to thereby adhere the silicone resin to the surface of the condensed aluminum phosphate layer.

[8] The method of producing an iron-based soft magnetic powder for dust cores according to [5] or [6], wherein the silicone resin in a solid state and the iron-based soft magnetic powder having the condensed aluminum phosphate layer are mixed to thereby adhere the silicone resin to the surface of the condensed aluminum phosphate layer.

[9] The method of producing an iron-based soft magnetic powder for dust cores according to any one of [5] to [8], wherein the total mass of the condensed aluminum phosphate powder and the silicone resin is 0.10 mass % or more and 0.60 mass % or less with respect to 100 mass % of the total mass of the iron-based soft magnetic powder, the condensed aluminum phosphate powder, and the silicone resin.

[10] The method of producing an iron-based soft magnetic powder for dust cores according to any one of [5] to [9], wherein a mass ratio of the condensed aluminum phosphate powder to the total mass of the condensed aluminum phosphate powder and the silicone resin is 0.2 to 0.9.

[11] A method of producing a dust core, the method comprising charging, into a die, the iron-based soft magnetic powder for dust cores according to any one of [1] to [3] or an iron-based soft magnetic powder for dust cores obtainable by the method of producing an iron-based soft magnetic powder for dust cores according to any one of [5] to [10], pressing the iron-based soft magnetic powder for dust cores, and thereafter subjecting the iron-based soft magnetic powder for dust cores to heat treatment at a temperature of 500° C. or more and 900° C. or less.

### Advantageous Effect

It is thus possible to provide an iron-based soft magnetic powder for dust cores that enables production of a dust core having high density and low iron loss, and a method of producing the same.

It is also possible to provide a dust core having high density and low iron loss, and a method of producing the same.

### DETAILED DESCRIPTION

One of the disclosed embodiments will be described below. Our iron-based soft magnetic powder for dust cores comprises: an iron-based soft magnetic powder; a condensed aluminum phosphate layer on particle surfaces of the iron-based soft magnetic powder; and a silicone resin layer on a surface of the condensed aluminum phosphate layer. That is, our iron-based soft magnetic powder for dust cores comprises the iron-based soft magnetic powder, the condensed aluminum phosphate layer, and the silicone resin layer in this order from inside. The condensed aluminum phosphate layer and the silicone resin layer function as insulating layers in our iron-based soft magnetic powder for dust cores.

<Iron-based Soft Magnetic Powder>

The iron-based soft magnetic powder is not limited, and examples thereof include a pure iron powder, an iron-based alloy powder (for example, a powder of a Fe—Al alloy, a Fe—Si alloy, Sendust, Permalloy, etc.), and an iron-based amorphous powder. A pure iron powder is preferable because it has favorable compressibility and easily achieves higher density, and a water-atomized pure iron powder is particularly preferable because it is available at relatively low price.

The iron-based soft magnetic powder may have an apparent density of 2.8 Mg/m³ or more and an average particle size of 10 μm or more and 200 μm or less.

If the apparent density is in this range, a dust core having high density can be easily produced using the obtained iron-based soft magnetic powder for dust cores. No upper limit is placed on the apparent density, but the apparent density may be typically 5.0 Mg/m³ or less.

If the average particle size is in this range, the iron-based soft magnetic powder for dust cores has sufficient flowability, and can be easily charged into a die in dust core production. To sufficiently reduce the eddy current loss of the dust core, it is preferable to adjust the average particle size depending on the intended use. For example, the average particle size may be 60 μm or more and 200 μm or less. Such average particle size is preferable, for example, for motor iron cores.

Herein, the average particle size of the iron-based soft magnetic powder is weight-based median diameter D50, i.e. the particle size that divides the powder into two equal-weight groups of larger particles and smaller particles.

<Condensed Aluminum Phosphate Layer>

By heating and mixing the iron-based soft magnetic powder and a condensed aluminum phosphate powder, a condensed aluminum phosphate layer can be formed on particle surfaces of the iron-based soft magnetic powder. Since the condensed aluminum phosphate layer can thus be formed by a dry process without using a solvent such as water, the problem of the oxidation of the iron-based soft magnetic powder can be avoided, and also a process of dissolving the iron-based soft magnetic powder in a solvent is unnecessary. This is advantageous in terms of equipment and workability.

The condensed aluminum phosphate layer formed by the heating and mixing forms a continuous coating. Herein, the continuous coating may be a complete coating or a partial coating, but refers to such a state in which the particles of the condensed aluminum phosphate powder are fused to the surfaces of the particles of the iron-based soft magnetic powder to form a continuous coating portion, as distinguished from a state in which the particles of the condensed aluminum phosphate powder adhere to the surfaces of the particles of the iron-based soft magnetic powder scatteredly. By the continuous coating, preferably most of the particle surfaces of the iron-based soft magnetic powder are covered with the condensed aluminum phosphate, and more preferably substantially the whole particle surfaces of the iron-based soft magnetic powder are covered with the condensed aluminum phosphate. Excellent adhesion of the condensed aluminum phosphate layer to the particle surfaces of the iron-based soft magnetic powder is presumed to be attributable to the occurrence of the reaction at the interface between the continuous coating of condensed aluminum phosphate and the iron-based soft magnetic powder.

Examples of the condensed aluminum phosphate include aluminum tripolyphosphate and aluminum metaphosphate obtained by heating aluminum primary phosphate to undergo dehydration, and a mixture thereof. Of these, aluminum dihydrogen tripolyphosphate is preferable.

The average particle size of the condensed aluminum phosphate powder may be 1 μm or more and 10 μm or less. If the average particle size is in this range, the condensed aluminum phosphate powder has sufficient flowability and favorable workability, and can easily form a uniform continuous coating. The average particle size is preferably 1.5 μm or more. The average particle size is preferably 7.5 μm or less.

Herein, the average particle size of the condensed aluminum phosphate powder is volume-based median diameter D50 measured by laser diffractometry.

A rotary vane type mixer may be used to heat and mix the iron-based soft magnetic powder and the condensed aluminum phosphate powder. Examples of the rotary vane type mixer include FM Mixer Series produced by Nippon Coke & Engineering Co., Ltd. and High Speed Mixer Series produced by Earthtechnica Co., Ltd.

The rotational speed of the mixer is not limited, and may be 100 rpm or more and 1000 rpm or less. If the rotational speed is in this range, the continuous coating can be formed efficiently, and also it is possible to prevent a decrease in compressibility and an increase in hysteresis loss caused by plastic deformation of the soft magnetic powder due to excessively fast stirring. The rotational speed is preferably 200 rpm or more. The rotational speed is preferably 800 rpm or less.

The heating and mixing may be performed so that the maximum arrival temperature during the mixing will be 100° C. or more and 200° C. or less. If the maximum arrival temperature during the mixing is in this range, the continuous coating of condensed aluminum phosphate can be easily formed on the particle surfaces of the iron-based soft magnetic powder, and the condensed aluminum phosphate can be easily prevented from changing in quality due to high temperature. The maximum arrival temperature during the mixing is preferably 130° C. or more, and more preferably 150° C. or more. The “temperature” herein refers to the temperature of the powder during the mixing. In the case where a rotary vane type mixer is used, the “temperature” herein refers to the temperature indicated by a thermocouple protruding from the tank wall of the stirring tank so as not to be in contact with the rotary vane.

The maximum arrival temperature during the mixing is the highest temperature of the powder during the mixing, i.e. the highest temperature of the powder containing the iron-based soft magnetic powder and the condensed aluminum phosphate powder measured by the thermocouple.

The heating and mixing are preferably performed in an inert gas atmosphere from the viewpoint of suppressing the oxidation of the iron-based soft magnetic powder. An example of the inert gas atmosphere is a nitrogen atmosphere.

After the heating and mixing, the iron-based soft magnetic powder having the condensed aluminum phosphate layer is preferably discharged from the mixer once the powder temperature has reached 80° C. or less and more preferably discharged from the mixer once the powder temperature has reached 60° C. or less, from the viewpoint of suppressing the oxidation. No lower limit is placed on the powder temperature at the time of discharge, and the powder temperature may be, for example, room temperature (0° C. to 30° C.) or more.

In the heating and mixing, an insulating fine powder (Al₂O₃, SiO₂, MgO, etc.), a basic substance (Al₂O₃, SiO₂, MgO, Mg(OH)₂, CaO, asbestos, talc, fly ash, etc.), and the like may be further added to the iron-based soft magnetic powder and the condensed aluminum phosphate powder. It is, however, preferable not to add such materials from the viewpoint of forming the continuous coating.

<Silicone Resin>

Silicone resin forms a Si—O bond having excellent heat resistance as a result of heat treatment, so that excellent insulation can be maintained even when the green compact is subjected to stress relief annealing at high temperature (for example, 600° C.) in dust core production.

The silicone resin is, for example, a resin-based silicone resin. For example, the silicone resin is a silicone resin having a trifunctional T unit of 60 mol % or more. In particular, a silicone resin in which 50 mol % or more of the functional groups on Si are methyl group is preferable. Examples include methylphenyl silicone resins (KR255, KR311, KR300, etc. produced by Shin-Etsu Chemical Co., Ltd.) and methyl silicone resins (KR251, KR400, KR220L, KR242A, KR240, KR500, KC89, etc. produced by Shin-Etsu Chemical Co., Ltd.). SR2400 and TREFIL R910 produced by Dow Corning Toray Co., Ltd. may also be used.

The silicone resin may be adhered to the surface of the condensed aluminum phosphate layer by a wet process using an organic solvent or a dry process not using a solvent. The dry process is preferable because it does not require safety measures for using an organic solvent and is advantageous in terms of cost, equipment, and workability.

In the case of using the wet process, a solution obtained by dissolving the silicone resin in an organic solvent and the iron-based soft magnetic powder having the condensed aluminum phosphate layer are kneaded and dried to adhere the silicone resin to the surface of the condensed aluminum phosphate layer.

Examples of the organic solvent include petroleum-based organic solvents such as alcohols, xylene, and toluene. The solid content concentration of the silicone resin in the solution may be 1 mass % to 10 mass %. The drying may be performed in the air. The drying temperature may be a temperature at which the organic solvent used evaporates and that is less than the curing temperature of the silicone resin.

In the case of using the wet process, it is preferable to use, as the silicone resin, SR2400 produced by Dow Corning Toray Co., Ltd., KR-311 or LR-220L produced by Shin-Etsu Chemical Co., Ltd., or the like.

In the case of using the dry process, the silicone resin in a solid state and the iron-based soft magnetic powder having the condensed aluminum phosphate layer are mixed to adhere the silicone resin to the surface of the condensed aluminum phosphate layer.

A rotary vane type mixer may be used for the mixing. Examples of the rotary vane type mixer include those described with regard to the formation of the condensed aluminum phosphate layer.

The rotational speed of the mixer may be 100 rpm or more and 2000 rpm or less. If the rotational speed is in this range, the silicone resin can be adhered efficiently, and also excessively fast stirring can be avoided. The rotational speed is preferably 200 rpm or more. The rotational speed is preferably 1500 rpm or less.

The mixing is performed, for example, by a method of starting mixing at room temperature and, when the powder temperature reaches 40° C. or more and 70° C. or less, discharging the powder from the mixer.

The silicone resin in a solid state is not limited, and may be, for example, powdery or flaky silicone resin. Regardless of the shape, the silicone resin is preferably thermosoftening.

As the silicone resin, TREFIL R-910 produced by Dow Corning Toray Co., Ltd. and KR-220LP produced by Shin-Etsu Chemical Co., Ltd. are preferable.

When adhering the silicone resin, one or more lubricants (for example, metal soaps such as lithium stearate, zinc stearate, and calcium stearate, and waxes such as fatty acid amide) may be added together with the silicone resin.

After adhering the silicone resin by the wet process or the dry process, heat treatment may be performed to increase the hardness of the adhered silicone resin. The temperature of the heat treatment is, for example, 150° C. or more and 250° C. or less. The heat treatment may be performed in the air, or performed in an inert gas atmosphere (for example, nitrogen atmosphere).

<Condensed Aluminum Phosphate Layer and Silicone Resin Layer>

In our iron-based soft magnetic powder for dust cores, the combination of the properties of the condensed aluminum phosphate layer and the properties of the silicone resin layer makes it possible to achieve favorable insulation. Sufficient insulation can be achieved even when the total mass of the condensed aluminum phosphate layer and the silicone resin layer is 0.60 mass % or less with respect to 100 mass % of the total mass of the iron-based soft magnetic powder, the condensed aluminum phosphate layer, and the silicone resin from the viewpoint of increasing the density of the dust core.

The total mass of the condensed aluminum phosphate layer and the silicone resin layer is preferably 0.10 mass % or more and more preferably 0.30 mass % or more, from the viewpoint of insulation. The total mass of the condensed aluminum phosphate layer and the silicone resin layer is preferably 0.50 mass % or less, from the viewpoint of increasing the density.

The mass ratio of the condensed aluminum phosphate layer is preferably 0.2 or more and 0.9 or less and more preferably 0.3 or more and 0.8 or less with respect to 1 of the total mass of the condensed aluminum phosphate layer and the silicone resin layer, from the viewpoint of ensuring the adhesion of the condensed aluminum phosphate layer to the iron-based soft magnetic layer and improving the heat resistance by the silicone resin.

The ratio of the total mass of the condensed aluminum phosphate layer and the silicone resin layer with respect to 100 mass % of the total mass of the iron-based soft magnetic powder, the condensed aluminum phosphate layer, and the silicone resin layer and the mass ratio of the condensed aluminum phosphate layer to the total mass of the condensed aluminum phosphate layer and the silicone resin layer are substantially consistent with the amounts of the iron-based soft magnetic powder, the condensed aluminum phosphate powder, and the silicone resin used in the production of the iron-based soft magnetic powder for dust cores, and can be controlled by adjusting the amounts of these raw materials.

<Dust Core>

By charging our iron-based soft magnetic powder for dust cores into a die, pressing the iron-based soft magnetic powder into a desired dust core shape, and then heat-treating it, a dust core can be obtained.

The pressing method is not limited, and any known formation method such as cold molding and die lubrication molding may be used.

The compacting pressure may be determined as appropriate depending on the intended use. The compacting pressure is preferably 10 t/cm² or more and more preferably 15 t/cm² or more, from the viewpoint of achieving high green density.

When performing the pressing, a lubricant may be optionally applied to the die walls or added to the powder. As a result of using the lubricant, the friction between the die and the powder can be reduced during the pressing, thereby suppressing a decrease in green density. Furthermore, the friction when removing the green compact from the die can be reduced, preventing cracks in the green compact at the time of removal. Preferable lubricants include metal soaps such as lithium stearate, zinc stearate, and calcium stearate, and waxes such as fatty acid amide.

The heat treatment after the pressing may be performed at a temperature of 500° C. or more and 900° C. or less. The heat treatment needs to be performed at 500° C. or more in order to release strain caused by the pressing. The heat treatment temperature is preferably 550° C. or more. If the heat treatment temperature is 900° C. or less, problems such as the magnetic properties degrading due to microstructure refinement by y transformation can be avoided easily.

When raising or lowering the temperature during the heat treatment, a stage at which the temperature is maintained constant may be provided.

Any of the following may be used without any problem as the atmosphere in the heat treatment: the air, an inert atmosphere (for example, nitrogen atmosphere), a reductive atmosphere, and a vacuum.

The atmospheric dew point may be determined as appropriate depending on the intended use.

When raising or lowering the temperature during the heat treatment, a stage at which the temperature is maintained constant may be provided.

### EXAMPLES

Our techniques will be described in more detail below by way of examples, although our techniques are not limited to the examples below.

The materials used in the examples are as follows:

Iron-based soft magnetic powder: water-atomized pure iron powder of 3.0 Mg/m³ in apparent density and 100 μm in average particle size (D50).

Aluminum tripolyphosphate powder: K-FRESH #100P produced by Tayca Corporation, powder of 5 μm in average particle size.

Silicone resin 1: SR2400 produced by Dow Corning Toray Co., Ltd.

Silicone resin 2: KR-220LP produced by Shin-Etsu Chemical Co., Ltd.

Silicone resin 3: TREFIL R-910 produced by Dow Corning Toray Co., Ltd.

Aluminum phosphate (AlPO₄): produced by Wako Pure Chemical Industries, Ltd., purity: 97%.

The examples were evaluated as follows:

Density: The dimensions and weight of each test piece were measured, and the density was calculated. The target value was set to 7.51 Mg/m³ or more, i.e. at least the value of No. 1 in Table 1.

Specific resistance: measured by the four-terminal method. The target value was set to 100 μm or more at which eddy current loss is sufficiently suppressed, based on research by Fujita, et al. (Yuichiro Fujita and Takanobu Saito, Denki-seiko, 79 (2008), p. 109-117).

Iron loss property: Each test piece was subjected to winding (primary winding: 100 turns; secondary winding: 20 turns), and the hysteresis loss (1.0 T, 1 kHz, DC magnetizing measurement device produced by METRON, Inc.) and the iron loss (1.0 T, 1 kHz, high frequency iron loss measurement device produced by METRON, Inc.) were measured. The eddy current loss was calculated from the measured values.

### First Example

The iron-based soft magnetic powder and the aluminum tripolyphosphate powder were charged into a high speed mixer (High Speed Mixer LFS-GS-2J produced by Earthtechnica Co., Ltd.) in the amount listed in Table 1, and stirred at a vane rotational speed of 500 rpm for 20 min, with the atmosphere in the stirring tank being nitrogen and the heater temperature in the stirring tank being set to 190° C. The maximum arrival temperature during the stirring was 168° C. After this, the powder was cooled to 60° C. in the stirring tank, and the powder having an aluminum tripolyphosphate layer was discharged from the stirring tank. SEM observation indicated that the aluminum tripolyphosphate layer formed a continuous coating on the particle surfaces of the iron-based soft magnetic powder. The maximum arrival temperature is the highest temperature indicated by a thermocouple in the stirring tank.

In the first example, silicone resin 1 was used as the silicone resin.

The silicone resin was dissolved in toluene, to produce a resin dilute solution (the solid content concentration of the silicone resin: 2.0 mass %). The iron-based soft magnetic powder having the aluminum tripolyphosphate layer was immersed in the resin dilute solution in the amount listed in Table 1, and stirred lightly. After this, the organic solvent was dried, and then heat treatment was performed in the air at 200° C. for 120 min to form a silicone resin layer.

The resultant powder having the silicone resin layer was charged into a die coated with a lubricant, and formed in a ring shape of 38 mm in outer diameter, 25 mm in inner diameter, and 6 mm in height at a compacting pressure of 15 t/cm². The resultant green compact was heat treated in nitrogen at 600° C. for 45 min, to yield a test piece.

The density, specific resistance, and magnetic properties of each obtained test piece were evaluated. The results are listed in Table 1.

TABLE 1

| | Soft magnetic powder for dust cores | | | | | | | | | |
|---|---|---|---|---|---|---|---|---|---|---|
| | | | Total | | | | | | | |
| | | | mass of | | | | | | | |
| | | | aluminum | | | | | | | |
| | | | tripoly- | Mass | | | | | | |
| | | | phosphate | ratio of | Test piece after heat treatment | | | | | |
| | Aluminum | | layer and | aluminum | | | | | Eddy | |
| | tripoly- | Silicone | silicone | tripoly- | | Specific | Iron | Hysteresis | current | |
| | phosphate | resin | resin layer | phosphate** | Density | resistance | loss | loss | loss | |
| No. | (mass %*) | (mass %*) | (mass %*) | (−) | (Mg/m³) | (μΩm) | (W/kg) | (W/kg) | (W/kg) | Remarks |
| 1 | 0.00 | 0.20 | 0.20 | 0 | 7.51 | 35 | 162 | 62 | 100 | Comparative |
| | | | | | | | | | | Example |
| 2 | 0.04 | 0.16 | 0.20 | 0.2 | 7.61 | 103 | 90 | 59 | 31 | Example |
| 3 | 0.08 | 0.12 | 0.20 | 0.4 | 7.65 | 143 | 90 | 59 | 31 | Example |
| 4 | 0.12 | 0.08 | 0.20 | 0.6 | 7.66 | 153 | 89 | 60 | 29 | Example |
| 5 | 0.16 | 0.04 | 0.20 | 0.8 | 7.67 | 149 | 86 | 57 | 29 | Example |
| 6 | 0.18 | 0.02 | 0.20 | 0.9 | 7.68 | 101 | 85 | 55 | 30 | Example |
| 7 | 0.20 | 0.00 | 0.20 | 1.0 | 7.68 | 14 | 239 | 56 | 183 | Comparative |
| | | | | | | | | | | Example |
| 8 | 0.00 | 0.50 | 0.50 | 0 | 7.45 | 75 | 102 | 62 | 40 | Comparative |
| | | | | | | | | | | Example |
| 9 | 0.10 | 0.40 | 0.50 | 0.2 | 7.52 | 143 | 89 | 59 | 30 | Example |
| 10 | 0.20 | 0.30 | 0.50 | 0.4 | 7.55 | 212 | 83 | 59 | 24 | Example |
| 11 | 0.30 | 0.20 | 0.50 | 0.6 | 7.56 | 258 | 80 | 58 | 22 | Example |
| 12 | 0.40 | 0.10 | 0.50 | 0.8 | 7.57 | 229 | 84 | 59 | 25 | Example |
| 13 | 0.45 | 0.05 | 0.50 | 0.9 | 7.58 | 160 | 87 | 59 | 28 | Example |
| 14 | 0.50 | 0.00 | 0.50 | 1.0 | 7.58 | 64 | 109 | 59 | 50 | Comparative |
| | | | | | | | | | | Example |

*With respect to 100 mass % of total of iron-based soft magnetic powder, aluminum tripolyphosphate powder, and silicone resin.
**Mass ratio of aluminum tripolyphosphate to total mass of aluminum tripolyphosphate powder and silicone resin.

As can be understood from Table 1, in Nos. 2 to 6 and 9 to 13 having both the aluminum tripolyphosphate layer and the silicone resin layer, the density was high, and the specific resistance met the target value. When comparing Nos. 2 to 6 with Nos. 1 and 7 equal in the total mass of the aluminum tripolyphosphate layer and the silicone resin layer but each having only either one of the layers, the specific resistance was noticeably high in Nos. 2 to 6. Likewise, when comparing Nos. 9 to 13 with Nos. 8 and 14, the specific resistance was noticeably high in Nos. 9 to 13. In Nos. 2 to 6 and 9 to 13, the iron loss was low, indicating high eddy current loss suppression effect.

### Second Example

In a second example, a powder having a phosphoric acid-based chemical conversion layer and a silicone resin layer was produced for comparison (No. 15). Silicone resin 1 was used as the silicone resin.

1 kg of the iron-based soft magnetic powder was charged into a high speed mixer (High Speed Mixer LFS-GS-2J produced by Earthtechnica Co., Ltd.). With the atmosphere in the stirring tank being nitrogen, 12 g of an aluminum phosphate aqueous solution (the solid content concentration of the aluminum phosphate: 10 mass %) was sprayed from above the stirring tank using nitrogen gas at a feeding rate of 2 g/min for 6 min.

After the spray, the powder was further stirred in the nitrogen atmosphere for 10 min while raising the temperature in the stirring tank to 120° C., to evaporate the water content. The powder was then cooled to 60° C. in the stirring tank, and the powder having an aluminum phosphate chemical conversion layer was discharged from the stirring tank.

On the resultant powder having the aluminum phosphate chemical conversion layer, a silicone resin layer was formed using a resin dilute solution so that the amount of the silicone resin layer would be 0.08 mass % in the powder after forming the silicone resin layer, in the same way as in the first example.

The obtained powder having the silicone resin layer was formed into a green compact and heat treated to yield a test piece, in the same way as in the first example.

Moreover, a powder was produced by forming a silicone resin layer on a powder obtained by mixing the iron-based soft magnetic powder and the aluminum tripolyphosphate powder without heating, for comparison (No. 16).

SEM observation on the powder obtained by mixing the iron-based soft magnetic powder and the aluminum tripolyphosphate powder without heating indicated that granular aluminum tripolyphosphate adhered onto the iron-based soft magnetic powder. A silicone resin layer was formed on this mixed powder using a resin dilute solution of silicone resin 1 in the same way as in the first example.

The obtained powder having the silicone resin layer was formed into a green compact and heat treated to yield a test piece, in the same way as in the first example.

The respective amounts of the iron-based soft magnetic powder, the aluminum tripolyphosphate powder, and silicone resin 1 in No. 16 are the same as those in No. 4 in the first example.

The density, specific resistance, and magnetic properties of each of these test pieces and the test piece of No. 4 in the first example were evaluated. The results are listed in Table 2.

TABLE 2

| | | | Test piece after heat treatment | | | | | |
|---|---|---|---|---|---|---|---|---|
| | Soft magnetic | | | | | | Eddy | |
| | powder for dust cores | | | Specific | Iron | Hysteresis | current | |
| | Phosphate used and | | Density | resistance | loss | loss | loss | |
| No. | layer formation method | | (Mg/m³) | (μΩm) | (W/kg) | (W/kg) | (W/kg) | Remarks |
| 4 | Aluminum | Heating | 7.66 | 153 | 89 | 60 | 29 | Example |
| | tripolyphosphate | and mixing | | | | | | |
| | powder | | | | | | | |
| 15 | Aluminum | Chemical | 7.67 | 140 | 112 | 82 | 30 | Comparative |
| | phosphate | conversion | | | | | | Example |
| | aqueous solution | treatment | | | | | | |
| 16 | Aluminum | Mixing at | 7.64 | 61 | 109 | 59 | 50 | Comparative |
| | tripolyphosphate | room | | | | | | Example |
| | powder | temperature | | | | | | |

As can be understood from Table 2, the iron loss in No. 4 was lower than the iron loss in No. 15. This is mainly attributed to the improvement in hysteresis loss. The reason for this is presumed to be as follows: In No. 15, the aluminum phosphate aqueous solution was used, so that the oxidation of the iron powder occurred in the chemical conversion treatment and the hysteresis loss increased. In No. 4, the oxidation was suppressed because the dry process was used.

In No. 16, the specific resistance was below the target value. The iron loss in No. 4 was lower than the iron loss in No. 16. This is mainly attributed to high eddy current loss suppression effect.

### Third Example

In a third example, the silicone resin layer formation method in No. 4 in the first example was changed to a dry process, and evaluation was conducted.

Silicone resin 2 was used as the silicone resin in No. 17. Silicone resin 3 was used as the silicone resin in No. 18.

The iron-based soft magnetic powder having the aluminum tripolyphosphate layer was produced in the same way as in No. 4 in the first example. This powder and the silicone resin were charged into a high speed mixer (High Speed Mixer LFS-GS-2J produced by Earthtechnica Co., Ltd.) in the amount listed in Table 3, and stirred with a vane rotational speed of 1000 rpm. The stirring was finished when the temperature in the stirring tank reached 50° C., and the powder having a silicone resin layer was discharged from the stirring tank.

The obtained powder having the silicone resin layer was formed into a green compact and heat treated to yield a test piece, in the same way as in the first example.

The density, specific resistance, and magnetic properties of each obtained test piece were evaluated. The results are listed in Table 3.

TABLE 3

| | | | Test piece after heat treatment | | | | | |
|---|---|---|---|---|---|---|---|---|
| | | | | | | | Eddy | |
| | | | | Specific | Iron | Hysteresis | current | |
| | Silicone resin and | | Density | resistance | loss | loss | loss | |
| No. | layer formation method | | (Mg/m³) | (μΩm) | (W/kg) | (W/kg) | (W/kg) | Remarks |
| 4 | Silicone resin 1 | Wet process | 7.66 | 153 | 89 | 60 | 29 | Example |
| | (SR2400) | | | | | | | |
| 17 | Silicone resin 2 | Dry process | 7.67 | 168 | 89 | 60 | 29 | Example |
| | (KR-220LP) | | | | | | | |
| 18 | Silicone resin 3 | Dry process | 7.69 | 169 | 89 | 60 | 29 | Example |
| | (TREFIL R910) | | | | | | | |

Nos. 17 and 18 in which the silicone resin layer formation method was changed to the dry process had density and specific resistance similar to No. 4 using the wet process, and the same low iron loss as No. 4.

### INDUSTRIAL APPLICABILITY

A dust core produced using our iron-based soft magnetic powder for dust cores has high density and thus has improved magnetic flux density, which contributes to high motor torque. The dust core also has low iron loss. The dust core is therefore highly useful.

1. An iron-based soft magnetic powder for dust cores, comprising:
an iron-based soft magnetic powder;
a condensed aluminum phosphate layer on particle surfaces of the iron-based soft magnetic powder; and
a silicone resin layer on a surface of the condensed aluminum phosphate layer,
wherein the condensed aluminum phosphate layer is a continuous coating, and
a total mass of the condensed aluminum phosphate layer and the silicone resin layer is 0.60 mass % or less with respect to 100 mass % of a total mass of the iron-based soft magnetic powder, the condensed aluminum phosphate layer, and the silicone resin layer.

2. The iron-based soft magnetic powder for dust cores according to claim 1, wherein the total mass of the condensed aluminum phosphate layer and the silicone resin layer is 0.10 mass % or more and 0.60 mass % or less with respect to 100 mass % of the total mass of the iron-based soft magnetic powder, the condensed aluminum phosphate layer, and the silicone resin layer.

3. The iron-based soft magnetic powder for dust cores according to claim 1, wherein a mass ratio of the condensed aluminum phosphate layer to the total mass of the condensed aluminum phosphate layer and the silicone resin layer is 0.2 to 0.9.

4. A dust core obtainable by pressing and heat treating the iron-based soft magnetic powder for dust cores according to claim 1.

5. A method of producing an iron-based soft magnetic powder for dust cores that includes: an iron-based soft magnetic powder; a condensed aluminum phosphate layer on a surface of the iron-based soft magnetic powder; and a silicone resin layer on a surface of the condensed aluminum phosphate layer, the method comprising
heating and mixing the iron-based soft magnetic powder and a condensed aluminum phosphate powder to obtain the iron-based soft magnetic powder having the condensed aluminum phosphate layer on particle surfaces thereof, and thereafter adhering a silicone resin to the surface of the condensed aluminum phosphate layer to form the silicone resin layer,
wherein a total mass of the condensed aluminum phosphate powder and the silicone resin is 0.60 mass % or less with respect to 100 mass % of a total mass of the iron-based soft magnetic powder, the condensed aluminum phosphate powder, and the silicone resin.

6. The method of producing an iron-based soft magnetic powder for dust cores according to claim 5, wherein a maximum arrival temperature in the heating and mixing is 100° C. or more and 200° C. or less.

7. The method of producing an iron-based soft magnetic powder for dust cores according to claim 5, wherein a solution obtained by dissolving the silicone resin in an organic solvent and the iron-based soft magnetic powder having the condensed aluminum phosphate layer are kneaded and thereafter dried to thereby adhere the silicone resin to the surface of the condensed aluminum phosphate layer.

8. The method of producing an iron-based soft magnetic powder for dust cores according to claim 5, wherein the silicone resin in a solid state and the iron-based soft magnetic powder having the condensed aluminum phosphate layer are mixed to thereby adhere the silicone resin to the surface of the condensed aluminum phosphate layer.

9. The method of producing an iron-based soft magnetic powder for dust cores according to claim 5, wherein the total mass of the condensed aluminum phosphate powder and the silicone resin is 0.10 mass % or more and 0.60 mass % or less with respect to 100 mass % of the total mass of the iron-based soft magnetic powder, the condensed aluminum phosphate powder, and the silicone resin.

10. The method of producing an iron-based soft magnetic powder for dust cores according to claim 5, wherein a mass ratio of the condensed aluminum phosphate powder to the total mass of the condensed aluminum phosphate powder and the silicone resin is 0.2 to 0.9.

11. A method of producing a dust core, the method comprising
charging, into a die, the iron-based soft magnetic powder for dust cores according to claim 1, pressing the iron-based soft magnetic powder for dust cores, and thereafter subjecting the iron-based soft magnetic powder for dust cores to heat treatment at a temperature of 500° C. or more and 900° C. or less.

12. The iron-based soft magnetic powder for dust cores according to claim 2, wherein a mass ratio of the condensed aluminum phosphate layer to the total mass of the condensed aluminum phosphate layer and the silicone resin layer is 0.2 to 0.9.

13. A dust core obtainable by pressing and heat treating the iron-based soft magnetic powder for dust cores according to claim 2.

14. A dust core obtainable by pressing and heat treating the iron-based soft magnetic powder for dust cores according to claim 3.

15. A dust core obtainable by pressing and heat treating the iron-based soft magnetic powder for dust cores according to claim 12.

16. The method of producing an iron-based soft magnetic powder for dust cores according to claim 6, wherein a solution obtained by dissolving the silicone resin in an organic solvent and the iron-based soft magnetic powder having the condensed aluminum phosphate layer are kneaded and thereafter dried to thereby adhere the silicone resin to the surface of the condensed aluminum phosphate layer.

17. The method of producing an iron-based soft magnetic powder for dust cores according to claim 6, wherein the silicone resin in a solid state and the iron-based soft magnetic powder having the condensed aluminum phosphate layer are mixed to thereby adhere the silicone resin to the surface of the condensed aluminum phosphate layer.
